(19) United States
(12) Patent Application Publication
(10) Pub. No.: US 2009/0108549 A1
(43) Pub. Date: Apr. 30, 2009

(54) FRAME AND PANEL SYSTEM FOR CONSTRUCTING MODULES TO BE INSTALLED ON AN AIRPLANE GROUND SUPPORT EQUIPMENT CART

(76) Inventors: Jeffrey E. Montminy, Riverview, FL (US); Brian A. Teeters, Palmetto, FL (US); Kyta Insixiengmay, Pinellas Park, FL (US)

Correspondence Address: PERRY HOFFMAN AND ASSOCIATES, P.C., P.O. BOX 1649, DEERFIELD, IL, 60015, US

(21) Appl. No.: 12/250,473

(22) Filed: Oct. 13, 2008

Related U.S. Application Data
(60) Provisional application No. 60/984,008, filed on Oct. 31, 2007.
(60) Provisional application No. 61/036,734, filed on Mar. 14, 2008.

(51) Int. Cl. B62B 3/00

(52) U.S. Cl. 280/47.34

(57) ABSTRACT

A frame, panel, and fastener system for use in constructing modules that are to be installed on a ground support equipment cart. The modules have a rectangular frame that is constructed primarily by connecting together members constructed as folded sheet metal tubes substantially rectangular in cross section but, on two adjoining sides, bent perpendicularly outwards to form a first shelf perforated with fastener mounting holes, these frame members having ends that may be fastened to pairs of ends of other like frame members at perpendicular angles to form the corners of the rectangular frame and of the modules. Panels having edges bent over to form stand-offs and perforated with fastener mounting holes are sized so the stand-offs rest upon the first shelves on plural sides of the rectangular frame. Plural fasteners have first fastener parts that are attached to the shelf fastener mounting holes and second fastener parts that are attached to the panel fastener mounting holes, with the fasteners aligned to join and to detachably hold the panels upon the first shelves to form removable side panels for the modules.

This application is a non provisional of provisional application Ser. No. 60/984,008 filed Oct. 31, 2007 (Atty. Docket No. 21588-P1) and provisional application Ser. No. 61/036,734 filed Mar. 14, 2008 (Atty. Docket No. 50-004 ITW 21588-P2).

### CROSS-REFERENCE TO RELATED APPLICATIONS

The present patent application is one of a set of commonly owned applications filed on the same day as the present application, sharing some inventors in common, and relating to airplane ground support equipment and carts. The other applications in this set, listed here, are hereby incorporated by reference into the present application: “A Multi-Voltage Power Supply for a Universal Airplane Ground Support Equipment Cart,” James W. Mann, III and David Wayne Leadingham (Ser. No. ______, Atty. Doc. No. 50-002 ITW 21608U); “An Adjustable Cooling System for Airplane Electronics,” Jeffrey E. Montminy and Steven E. Bivens (Ser. No. ______, Atty. Doc. No. 50-003 ITW 21585U); “A System of Fasteners for Attaching Panels onto Modules that are to be Installed on an Airplane Ground Support Equipment Cart,” Jeffrey E. Montminy, Brian A. Teeters, and Kyta Insixiengmay (Ser. No. ______, Atty. Doc. No. 50-005 ITW 21587U); “Airplane Ground Support Equipment Cart Having Extractable Modules and a Generator Module that is Separable from Power and Air Conditioning Modules,” James W. Mann, III and Jeffrey E. Montminy (Ser. No. ______, Atty. Doc. No. 50-006 ITW 21586U); “An Adjustable Air Conditioning Control System for a Universal Airplane Ground Support Equipment Cart,” James W. Mann, III, Jeffrey E. Montminy, Benjamin E. Newell, and Ty A. Newell (Ser. No. ______, Atty. Doc. No. 50-007 ITW 21606U); “A Compact, Modularized Air Conditioning System that can be Mounted Upon an Airplane Ground Support Equipment Cart,” Jeffrey E. Montminy, Kyta Insixiengmay, James W. Mann, III, Benjamin E. Newell, and Ty A. Newell (Ser. No. ______, Atty. Doc. No. 50-008 ITW 21583U); and “Maintenance and Control System for Ground Support Equipment,” James W. Mann, III, Jeffrey E. Montminy, Steven E. Bivens, and David Wayne Leadingham (Ser. No. ______, Atty. Doc. No. 50-009 ITW 21605U).

### BACKGROUND OF THE INVENTION

1. Field of the Invention

The present invention relates generally to the field of the design of sheet metal frames for covered enclosures, and more particularly to the design of frames and panels for air conditioning, power generation, and power conversion equipment modules that are to be installed on a universal airplane ground support equipment cart.

2. Description of the Related Art

When an airplane is on the ground with its engines shut down, the airplane is typically unable to provide power for its electrical systems and chilled air for its air conditioning systems; and some airplanes are also unable to provide liquid coolant for some critical electronic (or “avionic”) components. It is customary to connect such a grounded airplane to an airplane ground support equipment system. Such a system may have its components mounted upon a mobile equipment cart that is called an airplane ground support equipment cart and that may be parked, placed or mounted conveniently close to an airplane requiring ground support. Such a cart typically contains an air conditioner that can provide conditioned and cooled air to an airplane plus an electrical power converter that can transform power drawn from the local power grid into power of the proper voltage (AC or DC) and frequency required by the airplane. Such an airplane ground support equipment cart may also contain a diesel engine connected to an electrical generator that enables the cart to provide both air conditioning and also electrical power conversion for an airplane without any connection to the local power grid. And if an airplane requires a source of cooled liquid for its electronics, some carts may also include a source of liquid coolant.

In the past, particularly with regard to military airplanes, such ground support equipment carts have been custom designed to meet the specialized needs of a single particular type or class of airplane. Hence, a cart designed to support the specific requirements and needs of a first type or class of airplane cannot be used to support the differing specific requirements and needs of other types or classes of airplanes. Different airplanes typically may require different pressures and volumes of cooled air, different amounts of electrical power, different electrical voltage levels, and different electrical frequencies (or direct current). And different airplanes typically may require differing pressures and volumes of cooled liquid for use in cooling onboard electronics. Accordingly, every airport must be supplied with as many different types of ground support equipment carts as there are different types or classes of airplanes that may land and take off at each airport or military base. Problems arise when more airplanes of a particular type arrive at a specific location than there are ground support equipment carts suitably designed to service the needs of that particular type or class of airplane.

As an example of an airplane cart arrangement that provides air and electrical conditioning for an airplane, PCT patent application No. PCT/US2006/043312 (Intl. Pub. No. WO 2007/061622 A1 published on May 31, 2007) discloses an airplane ground support cart that has a modular design of its electrical conditioning components. This cart provides air conditioning and electrical power conversion as well as optional electrical power generation services to airplanes. FIG. 5 reveals that the cart disclosed in this patent application may receive interchangeable, modular power conversion modules. Thus, a module 72, which generates 3-phase 115 volt 400 Hz A.C. power, may be removed and replaced with a module 78, which generates 270 volt D.C. power. FIG. 6 illustrates that this cart may also accept a module 92, which generates 28 volt D.C. electrical power.

FIG. 2 of the above PCT patent application illustrates a typical arrangement of the mechanical components of a dual air conditioning system within an airplane ground support equipment cart 14. The air conditioner's mechanical components are spread all across the entire length of the cart 14. Two sets of condenser coils 34 are positioned at one end of the cart 14; and the thickness of the coils 34 and their housing, together with the thickness of the associated cooling fans, occupies roughly one-fifth of the cart's overall length. A filter and upstream evaporation coil 30 and a downstream evaporation coil 40 and outlet connection 42 (to which can be attached a duct leading to an airplane) are positioned at the other extreme end of the cart 14, occupying somewhat less than one-fifth of the cart's overall length. A blower fan 32, a discharge plenum 38, and two compressors 36 are shown positioned in the central portions of the cart 14. These mechanical components of the air conditioning system are not confined within a rectangular module within a portion of the volume of the cart 14—these components are spread all across the cart 14 and thus cannot be conveniently removed from the cart for servicing or for use away from the cart 14. Other cart components, such as a diesel engine 54 and generator 56 (shown in FIG. 4 of the PCT application) and an electrical power converter unit 72 (shown in FIG. 5 of the PCT application) are squeezed in among the air conditioning components wherever there is room. This intermixing of non-air-conditioning components with the air-conditioning components greatly complicates servicing of all the components, since they are all crowded into the same cramped space. A service man working on the air conditioner compressors or blowers may find the diesel engine 54 and the generator 56 are in the way of these components, for example.

The present invention has as its goal the realization of modules of similar design, both large and small, that may be installed on such a cart, interchanged with one another, and removed for convenient servicing. Larger modules might contain air conditioning equipment or power generation equipment, while smaller modules may contain power converter equipment, such as units that can convert 3-phase 460 volt 60 Hz A.C. incoming power into 270 volts DC or 115 volts 400 Hz A.C. Other modules may contain control panels and displays and computers and other such equipment.

These modules should be strong enough so that they may be lifted and moved about without damage. They should be relatively easy to disassemble so that repairs can be carried out without great difficulty, but there should be no loose parts that could be sucked up into a jet turbine engine, causing serious damage. The module design should lend itself readily to electromagnetic shielding. They should be relatively water and weather resistant, but there should be a minimum of internal enclosed channels where moisture could collect and do serious damage. The design of these modules should scale easily up or down into large or small modules as required by the nature of the ground support equipment being housed.

### SUMMARY OF THE INVENTION

An embodiment of the invention relates to a frame, panel, and fastener system for use in constructing modules that are to be installed on a ground support equipment cart. The modules have a rectangular frame that is constructed primarily by connecting together members constructed as folded sheet metal tubes substantially rectangular in cross section but, on two adjoining sides, bent perpendicularly outwards to form a first shelf perforated with fastener mounting holes, these frame members having ends that may be fastened to pairs of ends of other like frame members at perpendicular angles to form the corners of the rectangular frame and of the modules. Panels having edges bent over to form stand-offs and perforated with fastener mounting holes are sized so the stand-offs rest upon the first shelves on plural sides of the rectangular frame. Plural fasteners have first fastener parts that are attached to the shelf fastener mounting holes and second fastener parts that are attached to the panel fastener mounting holes, with the fasteners aligned to join and to detachably hold the panels upon the first shelves to form removable side panels for the modules.

### BRIEF DESCRIPTION OF THE DRAWINGS

FIG. 1 is an isometric view of an embodiment of a universal airplane ground support equipment cart.

FIG. 2 is an isometric view of the cart shown in FIG. 1 with the power generation portion of the cart separated from the rest of the cart.

FIG. 3 is an isometric view of an electrical power converter module of the cart shown in FIG. 1 to illustrate how it may be slid out of and away from the cart.

FIG. 4 is a perspective view of a set of modules shown placed upon an airplane ground support equipment cart's platform, with the module side panels removed.

FIG. 5 is a perspective view of the set of modules shown in FIG. 4 with the right-most power generation module and portion of the cart moved to the right and with one of the central electrical power converter modules shown slid out to the front to illustrate the way in which the modules may be separated.

FIG. 6 is an isometric view of an embodiment of the frame of a module designed in accordance with the present invention.

FIG. 7 is an isometric view of a cross section of a bottom module frame illustrating its shape, the module frame being shown supporting interior equipment support frames that can support air conditioning or electrical equipment within a module.

FIG. 8 is an isometric view of a cross section of two module frames illustrating how stair step-shaped members may strengthen the frame of a module by forming the frame into a hollow tube.

FIG. 9 is an isometric view of a cross-section of the frame of a module illustrating the positioning of fasteners and electromagnetic radiation shielding mounted on the frame.

FIGS. 10 and 11 present isometric views of the corner of a module, illustrating how a cover plate is fastened to each side of the module, with a cover plate removed in FIG. 10 and screwed down into place in FIG. 11.

FIGS. 12, 13, 14, and 15 present various isometric views illustrating the use of an embodiment of fasteners especially designed for the present invention to attach the frame of a module to a cover plate.

FIG. 16 presents a cross-sectional view, taken along the lines A-A in FIG. 10, illustrating in detail the nature of the fasteners for the module cover plates, including: a bolt; an insert to hold the bolt in place in a cover plate; a nut having a raised, internally-threaded shaft; and a washer that keeps the nut attached to the frame of a module.

FIG. 17 presents a cross-sectional view, taken along the lines B-B in FIG. 11, illustrating the relative position of a frame, the frame's cover plate, and a fastener that attaches the cover plate to the frame.

FIG. 18 presents a cross-sectional view, taken along the lines C-C in FIG. 11, illustrating the relative position of a frame and the frame's cover plate, with tin-plated, beryllium copper spring EMI shielding filling the gap between the frame and its cover plate.

FIG. 19 presents a sectional side view of the frame's cover plate, including an exploded view of an alternate design for the cover plate fastener and its washers.

FIG. 20 presents a perspective view of the cover plate upon which is mounted the fastener illustrated in FIG. 19.

### DETAILED DESCRIPTION OF THE INVENTION

The detailed description which follows is broken into three sections. Section A presents an introduction to the environment of the present invention, which relates to the design of a modularized universal airplane ground support equipment cart. Section B, which is particularly relevant to the present invention as claimed, presents a detailed mechanical description of installable and removable modules having removable cover panels which are designed for use in conjunction with such a cart. Section C presents a detailed description of the fasteners that are used to removably attach panels to the sides of the modules and which include provision that prevents them from coming loose from the panels and modules.

### A. Modular and Universal Airplane Ground Support Equipment Cart

Airplane ground support equipment carts are wheeled, towable carts or fixed mounted (permanently or temporarily) devices that provide air conditioning, avionics equipment liquid cooling, and electrical power conversion and generation services to airplanes whose engines are shut down. These carts preferably should be conveyed by military and other airplanes to airports and military bases all over the world, so it would be convenient and an advantage to have this equipment be no larger than a standard military equipment conveyance palette. However, many such carts today do not fit one standard palette, and this reduces the numbers of ground support equipment that is available in the field. Traditionally, such ground support equipment carts are custom-designed—they provide such services to only one type or class of airplane. Hence, different carts must be provided for each different type of airplane. Also traditionally, the air conditioning components mounted on such carts are so bulky that they occupy the entire area of the cart, making it necessary to sandwich electrical power conversion and other components wherever there is room and thereby making it extremely awkward to service or replace such cart-mounted components.

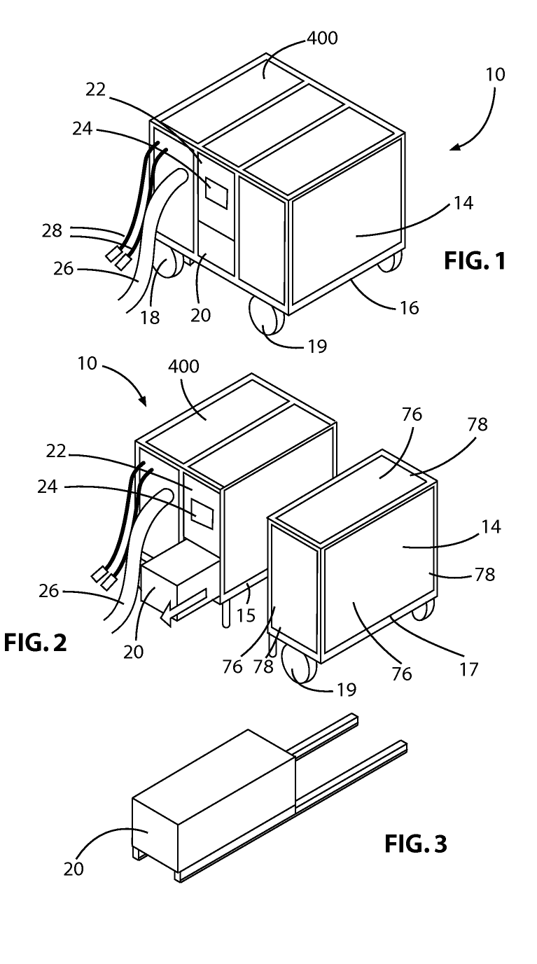

The present invention is embodied in a universal airplane ground support equipment cart—universal in the sense that it is designed to service the varied needs of a variety of types and classes of airplanes, rather than just one type or class. This ground support equipment cart is also modular—its components are rectangular modules that may be easily separated or removed from the cart for service or exchange. The modules may also be used independently of the cart, and modules not needed for a particular type of airplane may be readily removed and used elsewhere, standing by themselves, in a highly flexible manner. Such a cart 10 and several of its modules—an electrical power generation module 14, an electrical power conversion module 20, and a dual air conditioning module 400 (which also provides PAO liquid cooling)—are illustrated in simplified form in FIGS. 1-3. (Much more detailed drawings of these components are included in this application and also in the related applications cited above).

In use, the cart 10 is mounted near or drawn up to an airplane (not shown) by a suitable tractor or truck (not shown). An operator connects an air conditioning plenum or air duct 26 from the dual air conditioning module 400 to a cooled air input port (not shown) on the airplane. And if the airplane has avionics or other electronic components that require a supply of liquid coolant, then the operator also connects a pair of PAO liquid coolant conduits 28 from the air conditioning module 400 to a pair of PAO ports on the airplane. The operator then uses a suitable electrical power cable (not shown) to connect an electrical power output port or receptacle (not shown in FIGS. 1-3) on the electrical power conversion module 20 to a matching port or cable on the airplane. To supply the varying needs of different types of airplanes, there may be as many as two electrical power conversion modules 20 the cart 10, a first module 20 having both a 115 volt, 400 Hz AC power output port and also a separate 270 volt DC power output port, and a second module 1208 (FIG. 5) having a 28 volt DC power output port (one or the other of these modules 20 or 1208 may be removed from the cart 10).

Next, the operator depresses a “Start” pushbutton (not shown) on the front panel of a control module 22 having a display screen 24 that then displays a main menu (not shown). If the airplane is a T-50 Golden Eagle, the operator depresses a pushbutton adjacent the label “T-50 Golden Eagle” on this menu, and then the operator depresses a pushbutton adjacent the word “Start” on a “T-50” menu that then appears. In response, all of the modules automatically reconfigure themselves as needed to service this specific type of airplane with air conditioning of the proper pressure and volume of air, with electrical power of the proper type, voltage, and frequency, and with liquid coolant (if needed). If the operator selects the wrong type of airplane, pressure and air flow measurements can detect this and shut down the system, illuminating a colored status light (not shown) to signal an error and displaying an appropriate error message on the control panel 24 to the operator. The system is halted when the operator depresses a “Stop” pushbutton on the front of the control 22.

A universal airplane ground support equipment cart is designed to provide flexible support for the needs of many different types and classes of airplanes having widely varying air conditioning and liquid cooling and electrical power support needs. The present invention can provide different pressures and volumes of cooled air and cooled liquid to different airplanes, and it can provide different types and quantities of electrical power to different airplanes. It also provides a simplified, integrated control panel where airplane service personnel can simply select the type of airplane that is to be serviced and have the various appliances on the cart automatically configured to optimize the support for that particular type of airplane.

A modular airplane ground support equipment cart is one where the different support systems provided by the cart are each confined to rugged, compact, optionally EMI shielded, rectangular modules that may be easily removed, serviced, replaced, and used stand-alone separate from the cart and its other modular components.

In the cart 10, for example, a two-stage air conditioning module 400 contains all of the air conditioning components of the cart 10, including a liquid PAO cooling system. An electrical power converter module 20 contains the power conversion components of the cart 10, including a 270 volt D.C. supply and a 115 volt 400 Hz A.C. supply; and the module 20 may be replaced or supplemented with the other module 1208 (FIG. 5) that includes a 28 volt D.C. supply, providing up to three different types of electrical power conversion in accordance with the specialized needs of different types and classes of airplanes.

A power supply module 14 contains a diesel engine and a generator for producing 60 cycle, three-phase, 460 volt electrical power when the cart cannot be conveniently hooked up to a 360 to 500 volt, 50 or 60 cycle A.C., three phase supply provided by the local power grid. The power supply module 14 is confined to one end of the cart 10 and may be detached from the cart 10, as is illustrated in FIG. 2.

Any or all of these modules 14, 20, 400, and 1208 may optionally be equipped with an internal transformer (not shown) that transforms the incoming high voltage electrical power down to 120 volts or 240 volts at 50- or 60-Hz and feeds this low voltage to standard, weather protected outlets (not shown) which can be used to provide power to hand tools and to portable lighting equipment and the like, with ground fault protection also provided to these appliances.

As is illustrated in FIG. 1, the control module 22 is mounted on the cart 10 above the power converter module 20. The control module 22 has on its front panel a pair of start and stop pushbuttons, colored status lights, and the display screen 24. The display screen 24 has sets of four pushbuttons positioned adjacent the display screen 24's left and right sides (these pushbuttons and lights are not shown in this application). When turned on, the display screen 24 presents a main menu display (not shown) which permits airplane maintenance personnel to select the type of plane that is to be serviced by depressing one of the adjacent pushbuttons. A maintenance menu display (not shown) permits service personnel to view and (in some cases) to alter the state of the air conditioning and PAO module 400, the electrical power converter modules 20 and 1208, and the power supply module 14. The modules 14, 20, 22, 400, and 1208 are automatically networked together by a network (not shown) when they are installed upon the cart 10. In addition, each of the modules 14, 20, 22, 400, and 1208 is equipped with a network jack (not shown) that can be connected to an external portable computer (not shown) which can then serve as the control module and display for all of the modules, with mouse clicks on menus replacing depressions of pushbuttons.

The cart 10 is optionally mounted upon two wheel and axle truck assemblies 18 and 19. In the space on the cart 10 between the power generation module 14 and the two-stage air conditioning module 400, one or both of the electrical power converter modules 20 and 1208 may be slid into place and attached to the cart 10, as is illustrated in FIGS. 2 and 3. (If both are installed, they may be on opposite sides of the cart, as shown, or they may be installed one above the other.)

If the power generation module 14 is not required for a particular airplane support task, the module 14 and the wheel and axle truck assembly 19 beneath the module 14 may be completely detached from the rest of the cart 10, as is illustrated in FIG. 2, and removed to be used entirely separately elsewhere, wherever a portable source of 60 Hz, 460 volt, three-phase power is required. As illustrated in FIGS. 2 and 3, the electrical power converter modules 20 and 1208 may be slid out on tracks and locked in position to give service personnel convenient access for the servicing of these modules 20 and 1208 and their internal electrical and electronic components. They may also be removed for repair or for use elsewhere as stand-alone power converters, or they may be replaced with different power converter modules that generate different voltages and frequencies as needed for servicing different airplanes.

### B. Frame and Panel System for Constructing Modules

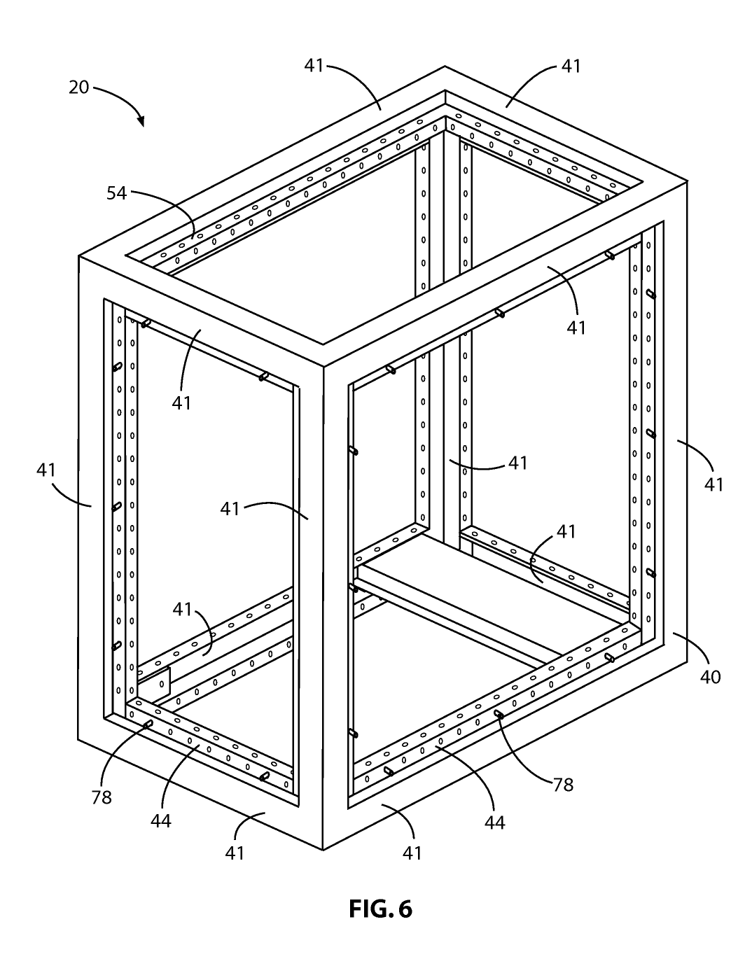

Referring now to FIG. 6, a rectangular frame 40 for a representative module 20 is shown in greater detail. The frame 40 is formed by welding together frame members 41 at their corners to form a unitary structure with considerable strength that constitutes the frame 40 of the module 20. The frame members 41 are formed from sheet metal by applying a series of 90 degree bends to the sheet metal to give the frame members 41 strength and to enable them to resist bending.

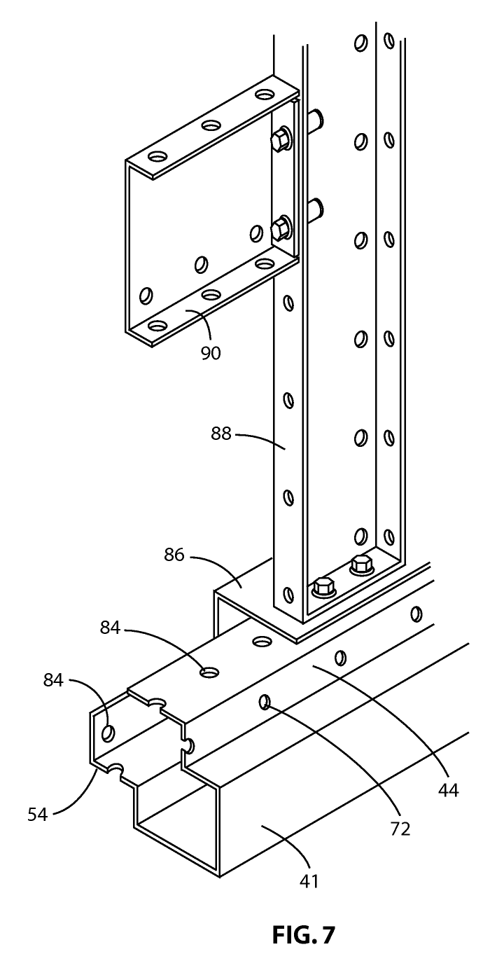

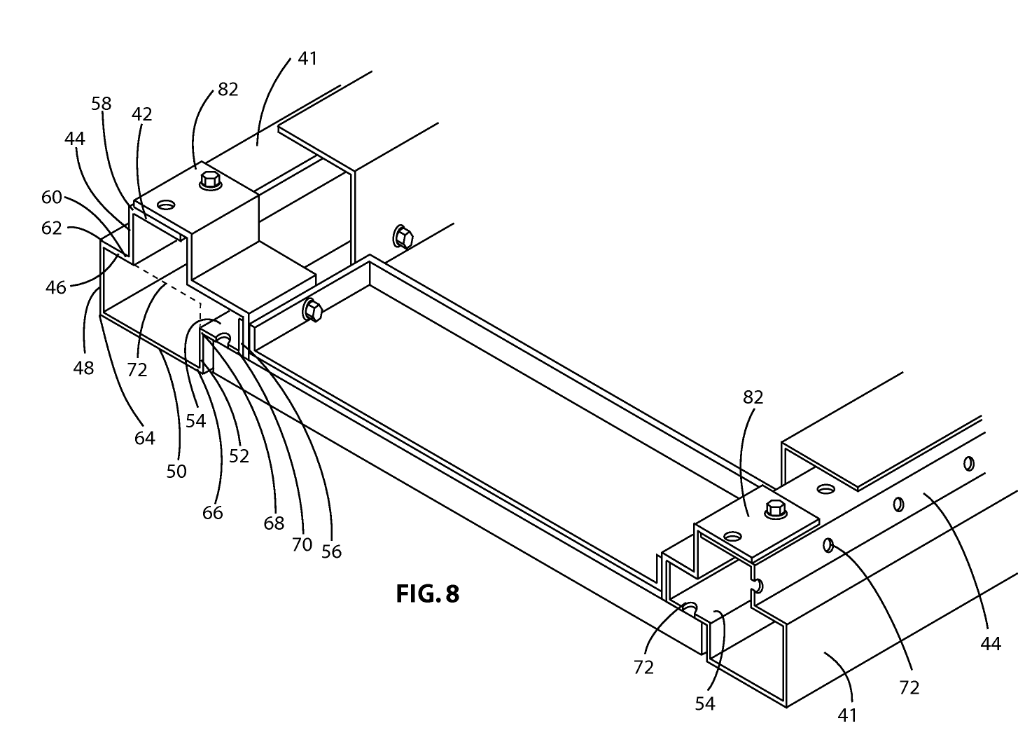

Viewed in cross section (See FIGS. 7, 8, and 9), the 90 degree bends in the frame members 41 can be seen. With reference particularly to the left side of FIG. 8, which presents an isometric cross-sectional view of the frame member 41, the frame member 41 can be seen to have been formed from sheet metal bent to form two adjoining outer surfaces 48 and 50, two inner surfaces 46 and 52, two shelves 44 and 54, and two interior mounting brackets 42 and 56 that are joined to each other by 90-degree bends at seven corners 58, 60, 62, 64, 66, 68, and 70 of the cross section. The three corners 62, 64, and 66, the four adjoining outer and inner surfaces 46, 48, 50, and 52, and a dotted line missing portion 72 (FIG. 8 only), taken together, form a rectangle. This indicates that the central portion of the frame member 41 (formed by the four surfaces 46, 48, 50, and 52) has a generally rectangular cross section, but with the dotted line missing portion 72 missing from what would otherwise be a closed, rectangular frame member.

The two inner surfaces 46 and 52 can be seen to be only about half as wide as the two outer surfaces 48 and 50. The two outer surfaces 48 and 50 and the corner 64 which joins the two outer surfaces 48 and 50 together form the outer, visible edges of the frame 40 and of the module 20. The remaining inner surfaces 46 and 52, the shelves 44 and 54, and the interior mounting brackets 42 and 56 and their respective corners 58, 60, 68, and 70 are hidden inside of the module 20 when cover plates 76 (shown in FIGS. 10 and 11) are installed.

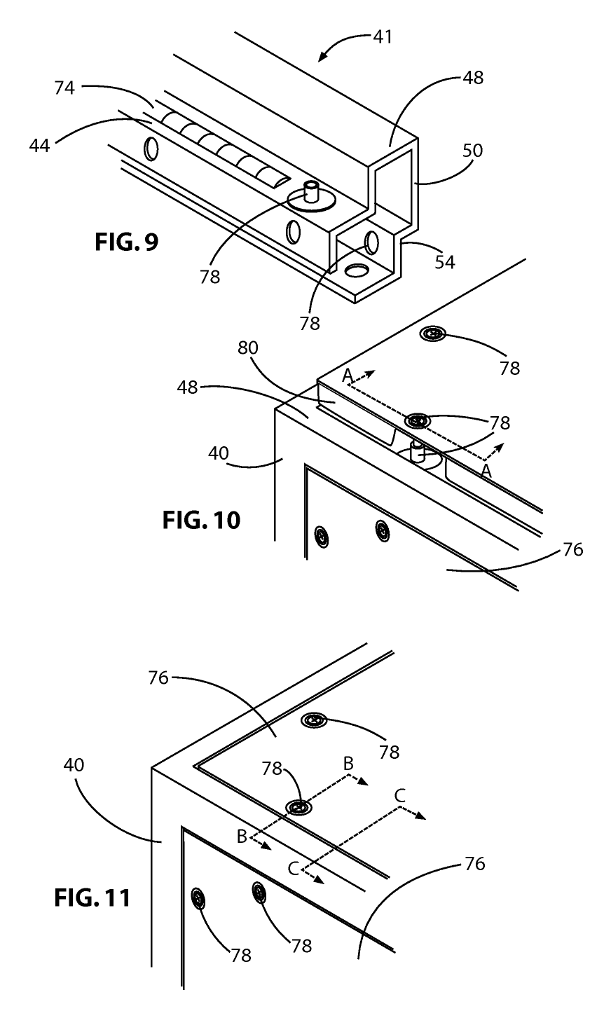

The shelves 44 and 54 respectively join the two inner surfaces 46 and 52 at the two corners 60 and 68, as shown, and project outwards from the inner surfaces 46 and 52 parallel to the respective outer surfaces 48 and 50 to form depressed (with respect to the respective outer surfaces 48 and 50 and corners 64 of the frame 40 and module 20) shelves that are perforated with spaced-apart holes 72 to which fasteners 78 (FIGS. 9, 10, and 11-16) and tin-plated, beryllium copper springs 74 serving as EMI shielding (FIGS. 9 and 18) may be attached. FIG. 9, for example, illustrates fasteners 78 that are attached to the shelves 44 and 54. (The details relating to the design of the fasteners 78 is presented below in the section which follows).

In one embodiment, tin plated, beryllium copper springs 74 (FIG. 9) are fastened into the holes 72 to provide good grounding of the panels 76 (FIGS. 2, 10, and 11). These tin plated, beryllium copper springs 74 are part number 81-02-11832 Springline beryllium copper gaskets supplied by Chomerics.

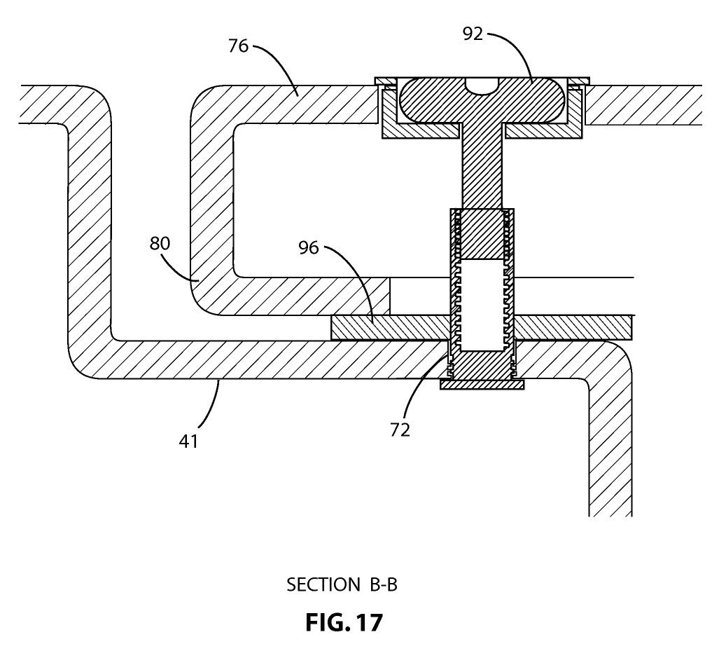

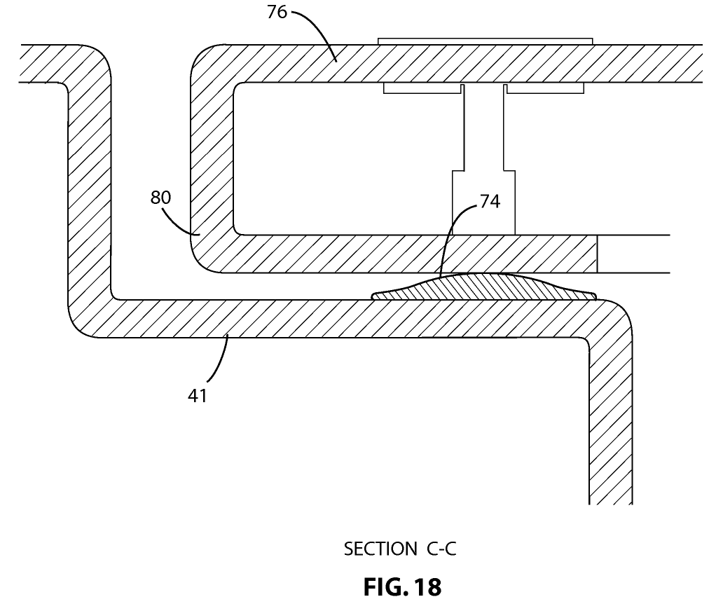

Note again that the shelves 44 and 54 which support the fasteners 78 are parallel to, but depressed inwards from, the respective outer surfaces 48 and 50. This provides room such that bent-over edges 80 of removable module side cover panels 76 (FIG. 10) may rest upon and against the shelves 44 and 54 or upon and against any tin-plated, beryllium copper springs 74 serving as EMI shielding that may be installed to prevent RF and EMI signals generated by computer or power switching components or by motors and solenoids or relays from leaking out, and also to keep out RF and EMI interference originating from external sources. The edges 80 may be assigned a depth such that the outer surfaces of the panels 76 lie in the same plane as the outer surfaces 48 and 50 of the frame members 41, thus giving the module 20 completely flat surfaces, as is illustrated in FIGS. 17 and 18 (which are drawn true to scale).

With reference again to FIG. 8, stair-step members 82 (which also can have just one 90 degree bend instead of three as shown or which can take on other shapes) may be strapped across the frame members 41 to connect the two surfaces 42 and 56 together, as shown in FIG. 8, to cause the frame members 41 to have a closed cross section over portions of their length, thereby giving frames 40 constructed from these reinforced frame members 41 considerably more strength and rigidity where needed. At other locations, the frame members 41 may be left with an open cross section to facilitate drainage of water from the frame and to facilitate its maintenance.

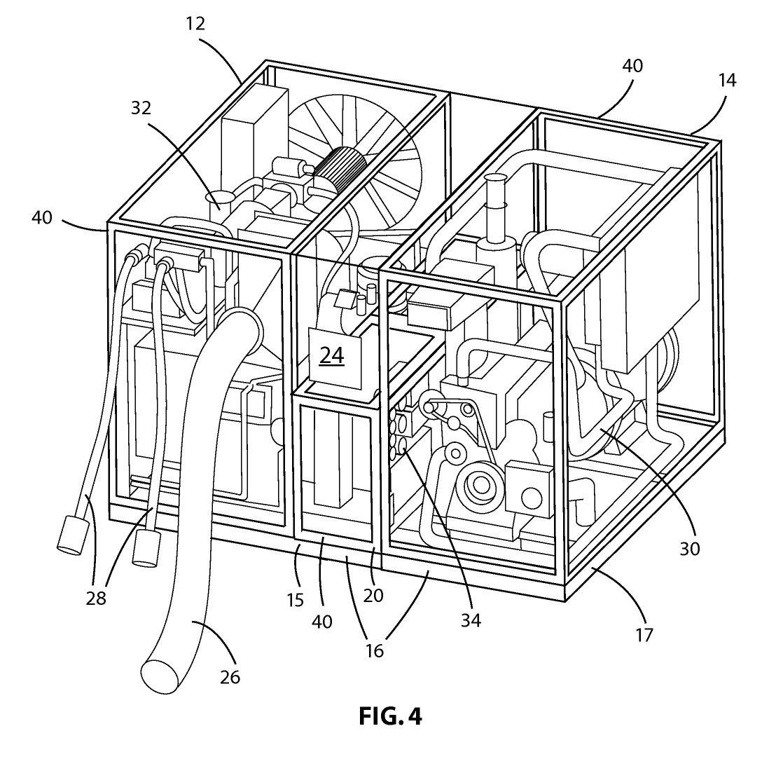

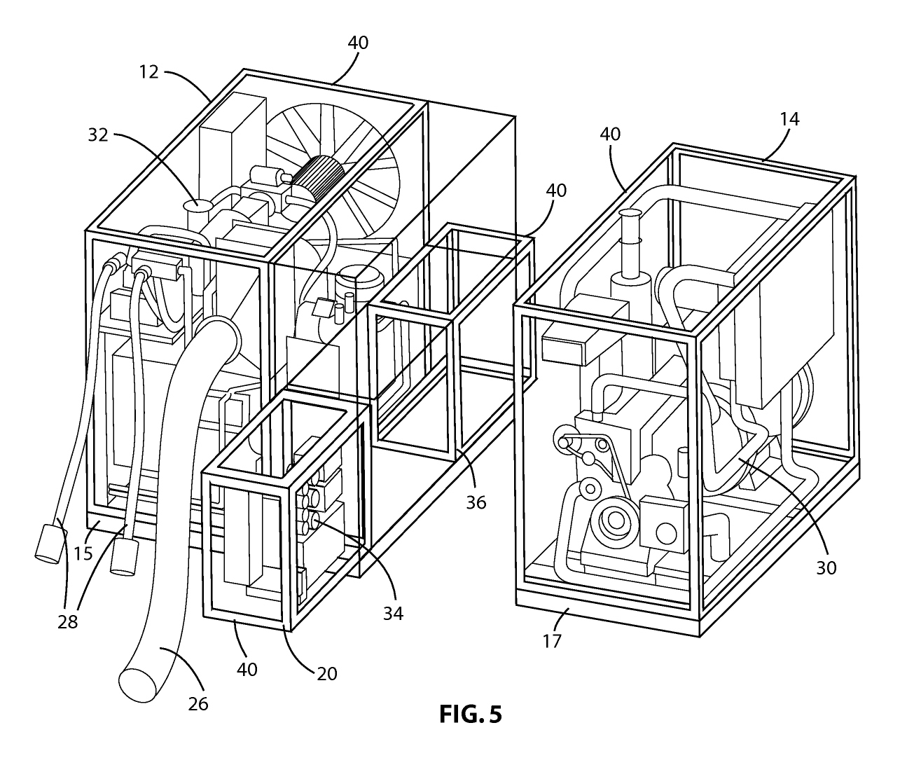

As shown in FIG. 7, additional holes 84 are provided in the two interior mounting brackets 42 and 56 for the mounting of internal brackets 86 having an L cross section as shown to which internal supports 88, 90 having a C cross section as shown may be attached that can then be used to support and suspend equipment 30, 32, and 34 (FIGS. 4 and 5) within each module 20. The stair-step members 82 also may be attached using the holes 84. The holes in these universal C cross section supports 88, 90 will always line up with holes in the frame, and this present a large number of equipment mounting options to the designer and to the modifier of a module 20.

### C. Details of Fasteners Used to Attach Removable Panels to the Sides of Modules

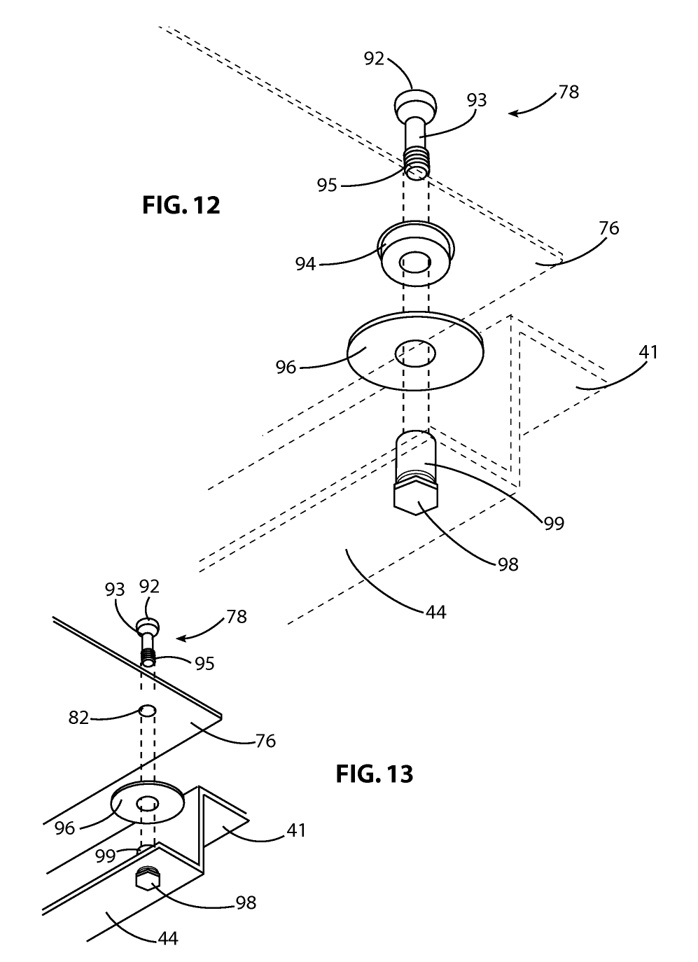

With reference to FIGS. 12-17, the detailed design of the fasteners 78 is presented. As explained above, the fasteners 78 mount in the holes 72 of the shelves 44 and 54 (see FIG. 7) and also in the holes 82 in the removable cover panels 76 (see FIG. 13).

Each fastener 78 comprises four components: two components 96 and 98 mounted in the holes 72 on the shelves 44 and 54, and two components 92 and 94 mounted in the holes 82 on the removable cover panels 76.

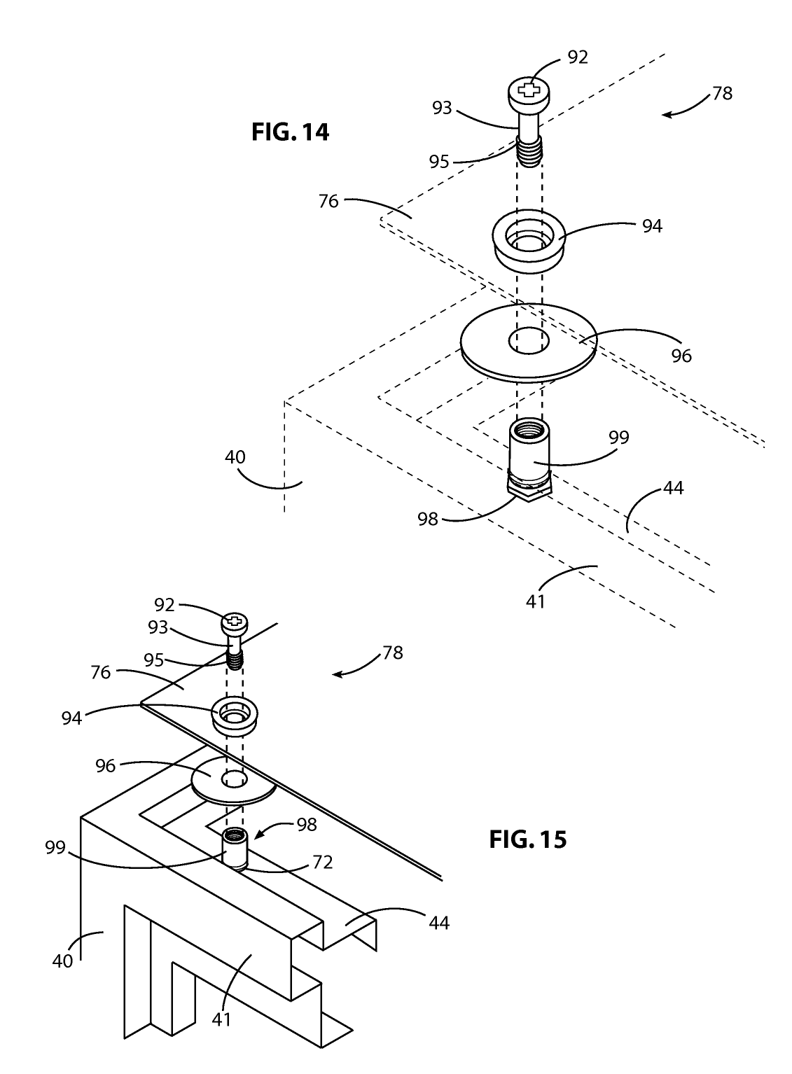

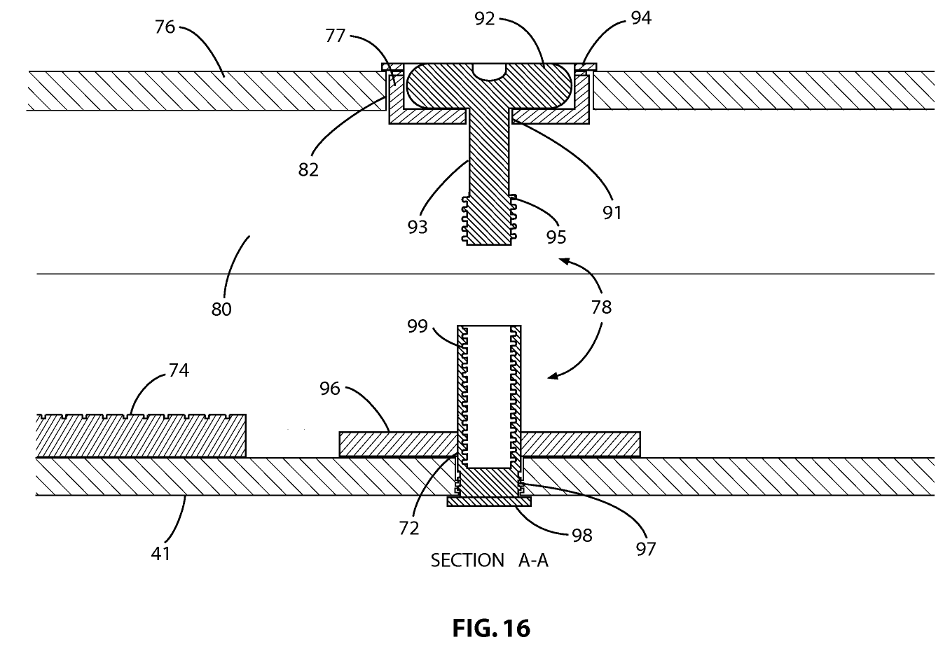

The four components of a fastener 78 can best be seen in FIGS. 13 and 15 which present an exploded view of the fastener 78, and also in FIGS. 16 and 17 which present cross-sectional views of the fasteners 78. FIGS. 12 and 14 also present exploded views but with the module frame 40 and the cover plate 76 rendered transparent and shown with dotted lines to reveal the details of the fastener 78. In the cross-sectional view presented by FIG. 16 (the cross section taken along the lines A-A in FIG. 10), an installed fastener 78 is shown mounted in a cover plate 76 and in a frame member 41, the cover plate 76 and the frame member 41 being slightly separated but in position to be fastened together. In the cross-sectional view presented in FIG. 17 (the cross section taken along the lines B-B in FIG. 11), the view is similar to that in FIG. 16 but the cover plate 76 and frame member 41 are shown fastened tightly together, with the edge 80 of the cover plate 76 shown resting on the nylon washer 96 (described below).

With reference to all of the FIGS. 13 through 16, the fastener 78 comprises a hexagonal nut 98 having mounted on its upper surface a hollow, internally threaded shaft 99; a nut retaining polyethylene (nylon) washer 96; an insertable hole liner 94; and a bolt 92 having a shaft 93-95 that is partly a threaded shaft 95 away from the head of the bolt and partly an unthreaded shaft 93 between the bolt head and the threaded shaft 95, as shown.

The nut 98 is a female, blind-threaded standoff, part number BSOS-832-16 manufactured by Penn Engineering. The insertable hole liner 94 and bolt 92 are called captive fasteners, part number F5-832-P8 manufactured by Southco.

As shown in the figures, the nut 98 has its shaft 99 press-fitted into one of the larger holes 72 in one of the shelves 44 or 54 with the hexagonal base positioned inside of the module 20 and with the shaft 99 pointing outwards towards the removable panel 76 as shown in the figures. The nylon washer 96 has been designed such that the inside diameter of the nylon washer 96 is somewhat less than the outside diameter of the shaft 99 such that when the nylon washer 96 is pressed downwards against the outward-facing surface of one of the shelves 44 or 54, the nylon washer 96 becomes captive. The major function of the nylon washer 96 is to provide a compression stop for the panel 76 to the shelves 44 and 54 of the frame members 41. This compression stop prevents the tin-plated, beryllium copper springs 74 serving as an EMI gasket from deforming beyond its elastic limit, which would otherwise permanently flatten such a gasket and render it less effective as an EMI shield.

The insertable hole liner 94 is a cup-shaped hollow washer having a hole 91 (see FIG. 91) in the bottom of the hole liner through which the bolt 92 may pass. This liner 94 is press-fitted downwards into a hole 82 that passes all the way through the panel 76. The insertable hole liner 94 is thus sunk into the upper surface of the panel 76.

The hole 82 that passes all the way through the panel 76 is large enough to accept the hole liner's core 77. The unthreaded portion 93 of the bolt 92 is smaller in diameter than the threaded portion 95. The hole 91 in the bottom of the insertable hole liner 94 is slightly smaller in diameter than the threaded shaft 95 portion of the bolt 92 and slightly larger in diameter than the unthreaded portion 93 of the bolt 92.

Accordingly, after the insertable hole liner 94 has been press-fitted into the hole 77, the bolt 92 may be screwed through the hole 91 in the hole liner 94. The bolt 92 will then be free to move up and down, with its non-threaded shaft 93 portion free to slide back and forth within the insertable hole liner 94. However, the bolt 92 cannot fall off of the panel 76 because the threaded shaft 93 cannot fit back out of the hole 91. Likewise, the nut 98 is retained in position and kept from falling out of the frame member 41 by the nylon washer 96 which fits tightly about the internally-threaded shaft 99 and holds the nut 98 in place. Yet the two parts 92 and 98 of the fastener 78 are held in position so that when the panel 76 is placed over one side of the frame 40, a screwdriver may be used to tighten the bolt 92 into the nut 98 and to thereby fasten the panel 76 on to the frame 40 of a module 20.

It is essential that the bolt 92 and the nut 98 not be permitted to come free and accidentally become sucked into a turbojet engine, where such components can easily cause many thousands of dollars of damage. The present invention provides protection against such an accident at minimal cost without in any way making it more difficult to fasten and unfasten the fasteners 78.

FIG. 17 shows the bolt 93 screwed firmly into the nut 72 such that the panel 76 is pressed tightly against the nylon washer 96 adjacent the nut 73. Elsewhere, the panel 76 makes contact with and depresses the tin-plated, beryllium copper springs 74, as shown in FIG. 18, thereby blocking radio frequency waves, particularly EMI, from leaking either into or out of the module 20.

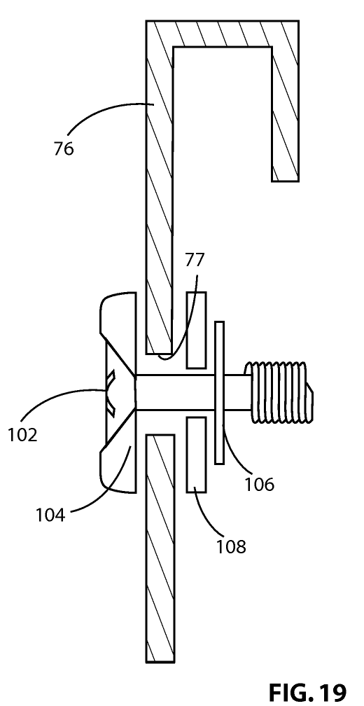

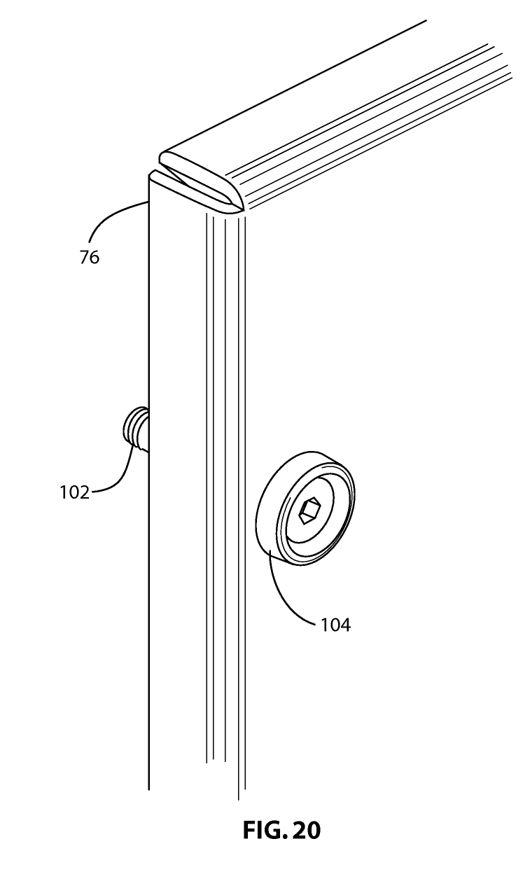

FIGS. 19 and 20 present an alternative arrangement that may be used instead of the captive fastener formed from the elements 93 and 94 shown in FIGS. 12 through 16. With reference to FIG. 19, a flat head screw 102 (Accurate Screw Machine Corporation part number 114132) having a hexagonal socket may be inserted through a finishing washer 104 (Accurate Screw Machine Corporation part number 16007) that is almost 0.6 inches in diameter and that is shaped to conform to the outside shape of the screw 102, as is shown in FIG. 20. These are passed through the hole 77 in the panel 76. A plastic washer 108 (McMaster-Carr part number 95647A121) having a 7/16″ outside diameter is placed over the shaft of the screw 102 along with a smaller washer (Accurate Machine Corporation part number W114050) on the other side of the panel 76 to keep the screw 102 from falling loose, as is shown and as has been described above. This arrangement allows the hole 77 to be enlarged so that a good deal of misalignment can be tolerated, but not large enough to permit the plastic washer 108 to pass through the hole 77.

While an embodiment of the invention has been disclosed, those skilled in the art will recognize that numerous modifications and changes may be made without departing from the true spirit and scope of the claims as defined by the claims annexed to and forming a par of this specification.

1. A frame, panel, and fastener system for use in constructing modules that are to be installed on a ground support equipment cart comprising:
a rectangular frame constructed primarily by connecting together members constructed as folded sheet metal tubes substantially rectangular in cross section but, on two adjoining sides, bent perpendicularly outwards to form a first shelf perforated with fastener mounting holes, said frame members having ends that may be fastened to pairs of ends of other like frame members at perpendicular angles to form the corners of the rectangular frame;
plural panels having edges bent over to form stand-offs and perforated with fastener mounting holes, the panels sized so the stand-offs rest upon the first shelves on plural sides of the rectangular frame; and
plural fasteners having first fastener parts attached to the shelf fastener mounting holes and having second fastener parts attached to the panel fastener mounting holes, the fasteners aligned to join and to detachably hold the panels upon the first shelves.

2. A frame, panel, and fastener system in accordance with claim 1 wherein:
the sheet metal tubes, in addition to being bent perpendicularly outwards to form a first shelf, are then bent perpendicularly inwards to form a second shelf perforated with mounting holes for internal support members.

3. A frame, panel, and fastener system in accordance with claim 2 further comprising:
a stair-step shaped strap constructed from folded sheet metal and sized to connect two adjacent second shelves together when attached thereto to thereby give the sheet metal tubes a closed cross section for added strength and rigidity where needed.

4. A frame, panel, and fastener system in accordance with claim 2 further comprising:
a strap constructed from folded sheet metal and sized to connect two adjacent second shelves together when attached thereto to thereby give the sheet metal tubes a closed cross section for added strength and rigidity where needed.

5. A frame, panel, and fastener system in accordance with claim 2 further comprising:
support members for equipment mounted upon and attached to said second shelves.

6. A frame, panel, and fastener system in accordance with claim 5 and further comprising:
equipment supporting rectangular platforms connected to and supported by said support members and arranged to provide support for equipment within said frames.
